(19) United States
(12) Patent Application Publication
(10) Pub. No.: US 2013/0042517 A1
(43) Pub. Date: Feb. 21, 2013

(54) BI-METAL POWER SUPPLY FISHING LURE

(71) Applicant: Jon David Danielson, Gaston, OR (US)

(72) Inventor: Jon David Danielson, Gaston, OR (US)

(21) Appl. No.: 13/586,997

(22) Filed: Aug. 16, 2012

Related U.S. Application Data
(60) Provisional application No. 61/524,591, filed on Aug. 17, 2011.

(51) Int. Cl. A01K 85/01; A01K 99/00; A01K 85/00

(52) U.S. Cl. 43/4.5; 43/42; 43/17.6; 43/17.1; 43/42.53

(57) ABSTRACT

A bi-metal power supply fishing lure comprises a housing having a water-tight internal cavity, an exterior surface, a forward end and an aft end; an anode mounted into said exterior surface of said housing such that said anode is exposed to an electrolyte when said bi-metal power supply fishing lure is immersed in said electrolyte; a cathode mounted into said housing such that said anode is exposed to an electrolyte when said bi-metal power supply fishing lure is immersed in said electrolyte; an electronic assembly, mounted within said water-tight internal cavity of said housing, in electrical contact with said anode and said cathode thereby creating a galvanic cell when said bi-metal power supply fishing lure is immersed in said electrolyte, said electronic assembly designed and configured to generate, store, regulate and distribute electrical power; and a low-voltage direct current device.

### CROSS-REFERENCE TO RELATED APPLICATIONS

This application claims the benefit of and is a continuation of prior U.S. Provisional Application No. 61/524,591, filed Aug. 17, 2011.

### FIELD OF THE INVENTION

The present invention relates generally to the field of fishing lures. More particularly, the present invention provides a useful and novel apparatus for generating power to supply electrical devices in a fishing lure.

### BACKGROUND OF THE INVENTION

A fishing lure is an object that is designed to simulate the prey of a fish. A fishing lure may be designed to employ movement, sound, vibration, or visual stimuli such as color or light to attract the attention of a fish and to stimulate a strike response from the fish.

The design of fishing lures is an art dating back to ancient times. In more recent history, attempts have been made to design fishing lures that utilize electrical properties and/or electrical power to induce a strike response in fish.

Many fishing lure designs that incorporate batteries, both rechargeable and non-rechargeable, are known. For example, in U.S. Pat. No. 4,763,433, Kulak discloses the use of hearing aid batteries to supply power to a light emitting diode. One disadvantage of designs that employ non-rechargeable batteries is limited battery life, and the attendant need to replace the battery. In U.S. Pat. No. 4,669,213, LeRoy discloses an illuminated fishing lure that comprises a rechargeable power unit, an external power source, and a means to transfer a charge from the external power source to the rechargeable power unit. Designs that employ a rechargeable battery also have the disadvantage of limited battery life, and the attendant need to recharge the battery from an external power source.

In addition to devices that rely upon rechargeable or replaceable batteries to provide electrical power, various methods have been employed to develop an electric voltage and/or an electromagnetic field.

In U.S. Pat. No. 5,159,773, Gentry et al. disclose a fishing lure in which a piezoelectric material is subjected to flexing as the fishing lure moves through water, thereby producing an electromotive force that is connected to an electronic device, such as a neon bulb. The application of this invention is limited to a lure body having an articulated or otherwise flexing design. In U.S. Pat. No. 6,457,275, Spurgeon discloses a fishing lure in which a steel ball is designed to strike a piezoelectric crystal, thereby generating an electric voltage that is transmitted to the surrounding water. The invention of Spurgeon is limited to transmitting voltage to the water, and does not provide a power supply that may generate and/or store power to be used by low-voltage devices. A further limitation is the inability of this device to develop a constant or regulated voltage.

In U.S. Pat. No. 7,240,453, Safwat discloses a device, which may be a fishhook or fishing lure, comprising anodic and cathodic segments arranged such that, when the device is immersed, a galvanic cell is established that generates an electro-magnetic field intended to stimulate the natural bioelectric field of living prey. While this invention employs a galvanic cell, it does not utilize the galvanic cell as a power supply that may generate and/or store power to be used by other low-voltage devices.

In U.S. Pat. No. 5,903,999, Petras discloses a device that generates alternating current by means of relative motion between a first body of a first metal and a second body made of a second metal. Application of the device disclosed by Petras is limited to hinged or otherwise articulated lure designs. Further, this invention requires conversion of the generated alternating current to direct current in order to power a direct current device, adding complexity to the circuit and power loss to the system. In addition, the device disclosed by Petras does not provide power storage capability.

In U.S. Pat. No. 4,959,919, Rao et al. disclose a fishing lure comprising a battery mounted inside a hollow lure body that is open to salt water when the lure is submerged, the battery employing the salt water as an electrolyte and used for illuminating an electric light bulb. The light bulb is mounted inside a light-transmissive body. The invention of Rao et al. is limited to functionality in salt water. A significant disadvantage of locating the battery electrodes in an internal passage within the fishing lure body is susceptibility to trapping materials, such as seaweed or debris in the water, in the internal passage, resulting in short circuiting and non-functionality of the device.

Other devices employ chemiluminescent means to illuminate a fishing lure. In Patent Publication US20080148622A1, Ashby discloses the introduction of a hydrogen peroxide activator into a flourescer solution. In U.S. Pat. No. 4,751,788, Mattison disclose a fishing lure that employs chemiluminescent capsules. In U.S. Pat. No. 3,708,903, Bercz et al. disclose a self-illuminating chemiluminescent fishing lure that employs a chemiluminescent material housed in a gas permeable member. Limited useful life is a disadvantage of chemoluminescent devices. Further, the utility of chemiluminescent devices is limited to the illumination function.

In U.S. Pat. No. 4,819,361, Boharski employs a propeller-driven generator to energize an incandescent light or a light emitting diode with fiber optics exposed to the exterior of a fishing lure. This propeller-driven design provides no power storage capability and requires motion of the lure in order to achieve functionality.

What is needed is a power supply, adapted to use in a fishing lure, that offers long life, operation with or without batteries, recharging capability for rechargeable batteries, and that provides power to low-voltage electrical devices. What is further needed is a power supply that is capable of operation in freshwater, as well as in saltwater, to extend the useful application and life of the power supply. An additional need is for a power supply that may be adapted to a wide variety of fishing lure designs.

### SUMMARY OF THE INVENTION

In view of the foregoing limitations and disadvantages inherent to the conventional apparatus in the related art, the present invention provides a useful and novel apparatus [hereinafter “bi-metal power supply fishing lure”] for generating power to supply electrical devices in a fishing lure.

A principal object of the present invention is to provide a fishing lure that enables continuous operation, long life and minimal maintenance.

In one aspect, the present invention may comprise a robust and long-lasting bi-metal power supply fishing lure that establishes a galvanic cell which functions without the need for replaceable batteries. Further, the present invention makes use of the galvanic corrosion electrochemical process to allow for continuous, 24-hour per day operation and/or recharging of its one or more optional rechargeable batteries.

A further object of the present invention is that may be adapted to a wide variety of embodiments and be configurable to simulate various characteristics of a variety of prey.

In one aspect, the present invention may be adapted to a wide variety of fishing lure designs, including articulated or non-articulated designs, in virtually any shape, size, color or pattern.

In another aspect, the present invention may be adapted to function with a wide variety of low-voltage devices, including devices that produce movement, sound, vibration, electromagnetic fields, and/or visual stimuli such as illumination.

In still another aspect, the present invention may be configured and designed to function in fresh water and/or salt water.

An additional object of the present invention is to provide the capability to recharge batteries while the fishing lure is in use and without the need for an external charging power supply.

In one aspect, the present invention may comprise one or more rechargeable batteries that may be recharged by means of the fishing lure's onboard galvanic cell.

Other objects, aspects and advantages of the present invention will become readily apparent to those with skill in the art from the following figures, descriptions and claims. As will be appreciated by those with skill in the related art, the invention may be implemented in a plurality of equivalent embodiments. Such alternative embodiments, and their attendant objects, aspects and advantages, are within the scope of the present invention and, therefore, the examples set forth herein shall not be limiting.

### BRIEF DESCRIPTION OF THE DRAWINGS

The nature of this invention, as well as all its objects, aspects and advantages, will become readily apparent and understood upon reference to the following detailed description when considered in conjunction with the accompanying drawings, in which like reference numerals designate like parts throughout the figures thereof, and wherein:

FIG. 1 presents a perspective view of a bi-metal corrosion power supply fishing lure according to one exemplary embodiment of the invention;

FIG. 2 presents a front view of the device of FIG. 1;

FIG. 3 presents a right side view of the device of FIG. 1;

FIG. 4 presents an aft end view of the device of FIG. 1;

FIG. 5 presents a block diagram of the device of FIG. 1; and

FIG. 6 presents a schematic diagram of an electronic assembly of the device of FIG. 1.

### DETAILED DESCRIPTION OF THE INVENTION

The following description is provided to enable a person skilled in the relevant art to make and use the invention, and sets forth the best modes contemplated by the inventor of carrying out the invention. The present invention shall not be limited to the examples disclosed. Rather, the scope of the invention shall be as broad as the claims will allow.

Various inventive features are described below that can each be used independently of one another or in combination with other features. However, any single inventive feature may not address any of the disadvantages discussed above, or might only address one of the disadvantages discussed above. Further, one or more of the disadvantages discussed above may not be fully addressed by any of the features described below.

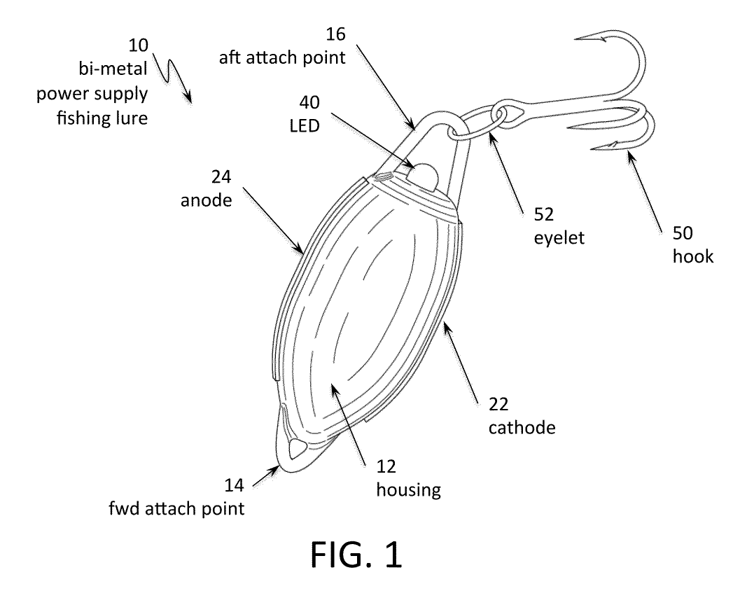

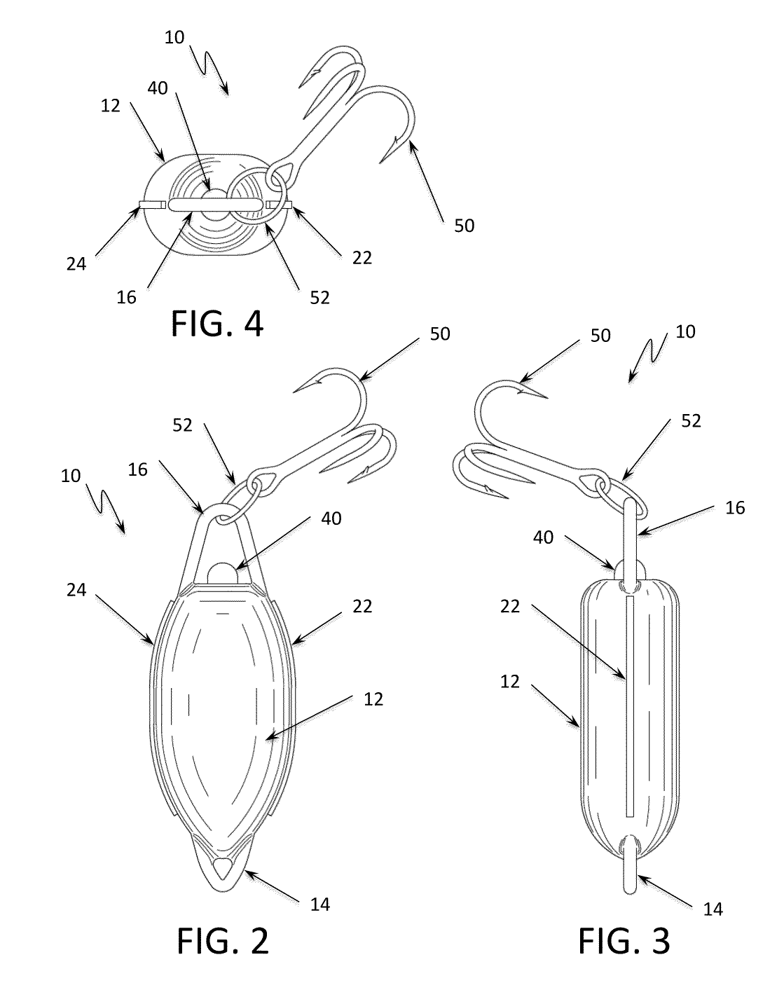

Referring now to the drawings, FIGS. 1 through 4 present perspective, front, right side and aft end views of a bi-metal power supply fishing lure 10 according to one exemplary embodiment of the invention.

According to this exemplary embodiment, the bi-metal power supply fishing lure 10 may comprise a housing 12 forming a water tight internal cavity, and may have a forward attach point 14 for attaching the housing 12 to a fishing line or other fishing tackle (not shown) and an aft attach point 16 for attaching a hook 50 or other fishing tackle to the housing 12. In this exemplary embodiment, an eyelet 52 may be employed to attach the hook 50 to the housing 12.

An anode 22 may be mounted into one side of the housing 12, and a cathode 24 may be mounted into the opposite side of the housing 12. A light emitting diode (LED) 40 may be mounted into the aft end of the housing 12.

In alternative embodiments of the invention, a plurality of anodes and/or cathodes may be mounted into the housing 12.

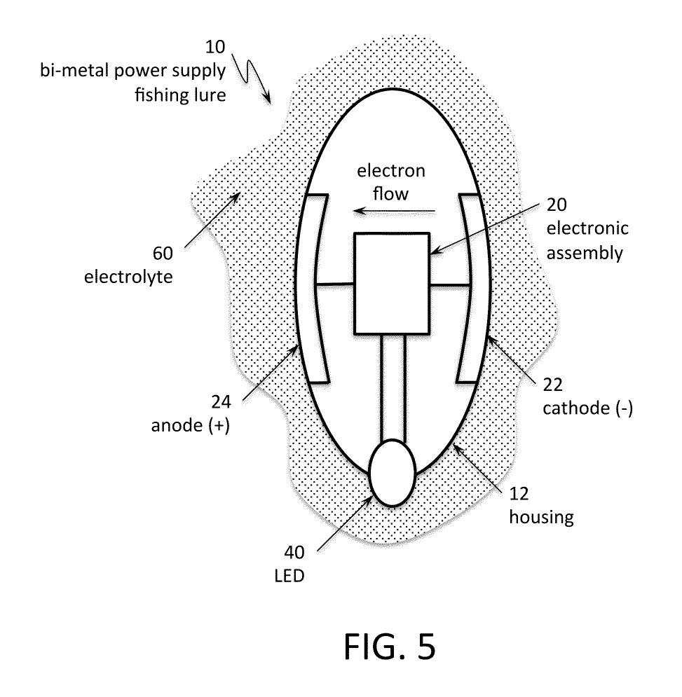

FIG. 5 presents a block diagram of the device of a bi-metal power supply fishing lure 10 according to one exemplary embodiment of the invention. An electronic assembly 20 may be housed within the internal cavity of the housing 12. The electronic assembly 20 may be in electrical contact with both the anode 22 and the cathode 24, and may provide electrical contact between the anode 22 and the cathode 24. When the bi-metal power supply fishing lure 10 is immersed in an electrolyte 60, such as fresh water or salt water, a galvanic cell may be established and voltage may be generated.

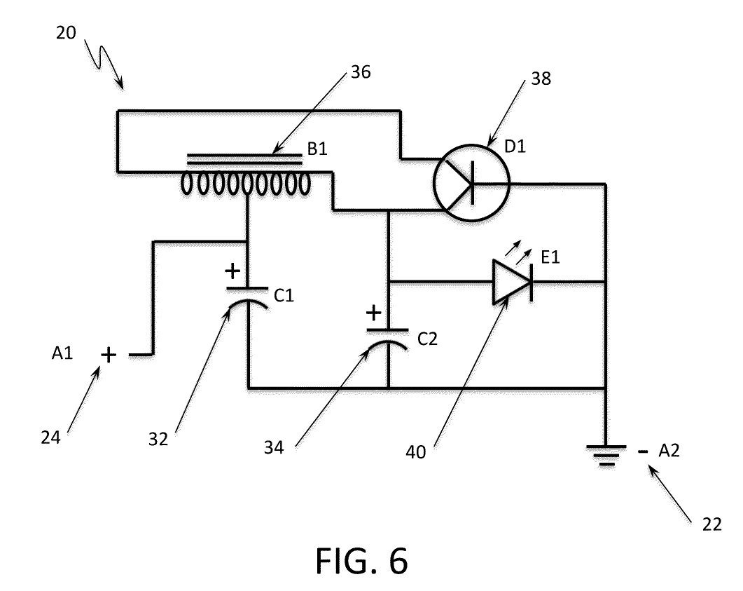

FIG. 6 presents a schematic diagram of an electronic assembly 20 according to one exemplary embodiment of the invention. The electronic assembly 20 of FIG. 6 is designed and configured to function in fresh water. In this embodiment, the anode 24 may be made of silver, preferably with purity greater than 92.5 percent, and form the positive side of the galvanic cell. The cathode 22 may be made of galvanized steel and form the negative side of the galvanic cell. A voltage may be induced in an inductor 36 that may be a toroidal coil wound in a double helix configuration, or any useful inductor design type. The inductor 36 may regulate the voltage to a transistor 38. A first capacitor 32 may function to store power from the bi-metal power supply and may be rated at 3.6 volts and a capacitance of 2200 microfarad. In this exemplary embodiment, current from the first capacitor 32 may switched by the transistor 38 to accommodate flashing intermittent or patterned function of the LED 40. A second capacitor 34 may also function to store power from the bi-metal power supply and may be rated at 3.6 volts and a capacitance of 0.0012 microfarad. In this exemplary embodiment, current from the second capacitor 34 may be switched or may provide direct, constant power to the LED 40. A transistor 38 provides amplification and switching functions, and may be an S8550 or equivalent transistor. An LED 40 functions to convert electrical energy into light, and may be rated at 3 volts.

The bi-metal power supply fishing lure may comprise any useful anode/cathode material combination.

In alternative embodiments of the present invention, the LED 40 may be replaced with any useful low-voltage device, including but not limited to multiple LEDs, one or more illuminating elements, one or more sound generating device, and/or one or more vibration generating device. The low-voltage devices may be mounted within the water-tight internal cavity of the housing 12, to the external surface of the housing 12, or through the wall of the housing 12.

As will be appreciated by those with skill in the related arts, in alternative embodiments of the invention the electronic assembly may be designed and configured to accommodate a variety of anode/cathode material combinations and/or electrolytes, a variety of low-voltage devices, and/or a variety of power level, switching and regulating requirements.

In alternative embodiments of the invention, one or more rechargeable batteries may be added to store energy generated by the bi-metal power supply. For example, in the architecture illustrated in FIG. 6, the one or more rechargeable batteries may be substituted for the first capacitor 32, the second capacitor 34, or the LED 40.

In an alternative embodiment of the invention, a switch may be added to enable a user to turn the bi-metal power supply on or off. The switch may be of any useful design type.

In alternative embodiments of the present invention, the housing 12 may be made in a variety of shapes and colors to simulate the prey of various fish species.

The housing 12 may be made of any material that does not adversely affect the operation of the bi-metal galvanic cell, such as plastic or other non-conducting material.

The LED 40 or other illuminating element may be mounted within the internal cavity of the housing 12, and the housing 12 may be made of a translucent material to permit the illumination to penetrate the housing 12.

The elements of a bi-metal power supply fishing lure may be modified, interchanged, separated or combined, or additional elements added without departing from the spirit of the invention. The invention may be practiced in alternative embodiments other than those illustrated in the Figures. Such modifications, combinations, additions and alternatives are within the contemplation of the present invention. The exemplary embodiments and disclosed are not intended to limit the scope of this invention. Accordingly, the scope of the invention should be determined not by the embodiments illustrated, but by their legal equivalents, and shall be as broad as the claims will allow.

What is claimed is:

1. A bi-metal power supply fishing lure designed to simulate the prey of a fish, comprising:
a housing having a water-tight internal cavity, an exterior surface, a forward end and an aft end;
an anode mounted into said exterior surface of said housing such that said anode is exposed to an electrolyte when said bi-metal power supply fishing lure is immersed in said electrolyte;
a cathode mounted into said housing such that said anode is exposed to an electrolyte when said bi-metal power supply fishing lure is immersed in said electrolyte;
an electronic assembly, mounted within said water-tight internal cavity of said housing, in electrical contact with said anode and said cathode thereby creating a galvanic cell when said bi-metal power supply fishing lure is immersed in said electrolyte, said electronic assembly designed and configured to generate, store, regulate and distribute electrical power; and
a low-voltage direct current device affixed to or within said housing, said low-voltage direct current device in electrical contact with said electronic assembly.

2. The bi-metal power supply fishing lure according to claim 1, further comprising a forward attach point, proximal to said forward end of said housing, designed and configured to attach said housing to a fishing line or other fishing tackle.

3. The bi-metal power supply fishing lure according to claim 1, further comprising an aft attach point, proximal to said aft end of said housing, designed and configured to attach said housing to a fishing hook or other fishing tackle.

4. The bi-metal power supply fishing lure according to claim 1, further comprising a fishing hook.

5. The bi-metal power supply fishing lure according to claim 1, wherein said anode is made of silver and said cathode is made of galvanized steel.

6. The bi-metal power supply fishing lure according to claim 1, wherein said electrolyte is salt water.

7. The bi-metal power supply fishing lure according to claim 1, wherein said electrolyte is fresh water.

8. The bi-metal power supply fishing lure according to claim 1, wherein said low-voltage direct current device is a light emitting diode or other illumination device.

9. The bi-metal power supply fishing lure according to claim 1, wherein said low-voltage direct current device is a vibration-generating device.

10. The bi-metal power supply fishing lure according to claim 1, wherein said low-voltage direct current device is a sound-generating device.

11. The bi-metal power supply fishing lure according to claim 1, further comprising a switch designed and configured to turn said bi-metal power supply on or off.

12. The bi-metal power supply fishing lure according to claim 1, further comprising one or more rechargeable batteries.

13. A method of manufacturing a bi-metal power supply fishing lure designed to simulate the prey of a fish comprising:
providing a housing having a water-tight internal cavity, an exterior surface, a forward end and an aft end;
mounting an anode into said exterior surface of said housing such that said anode is exposed to an electrolyte when said bi-metal power supply fishing lure is immersed in said electrolyte;
mounting a cathode into said housing such that said anode is exposed to an electrolyte when said bi-metal power supply fishing lure is immersed in said electrolyte;
mounting an electronic assembly within said water-tight internal cavity of said housing, said electronic assembly in electrical contact with said anode and said cathode thereby creating a galvanic cell when said bi-metal power supply fishing lure is immersed in said electrolyte, said electronic assembly designed and configured to generate, store, regulate and distribute electrical power; and
affixing a low-voltage direct current device to or within said housing, said low-voltage direct current device in electrical contact with said electronic assembly.

14. A method of attracting fish to a bi-metal power supply fishing lure designed to simulate the prey of a fish comprising:
providing a housing having a water-tight internal cavity, an exterior surface, a forward end and an aft end;
mounting an anode into said exterior surface of said housing such that said anode is exposed to an electrolyte when said bi-metal power supply fishing lure is immersed in said electrolyte;
mounting a cathode into said housing such that said anode is exposed to an electrolyte when said bi-metal power supply fishing lure is immersed in said electrolyte;
mounting an electronic assembly within said water-tight internal cavity of said housing, said electronic assembly in electrical contact with said anode and said cathode thereby creating a galvanic cell when said bi-metal power supply fishing lure is immersed in said electrolyte, said electronic assembly designed and configured to generate, store, regulate and distribute electrical power; and
affixing a low-voltage direct current device to or within said housing, said low-voltage direct current device in electrical contact with said electronic assembly; and
immersing said bi-metal power supply fishing lure into an electrolyte.

15. The method according to claim 14, further comprising manipulating said bi-metal power supply fishing lure through the electrolyte thereby simulating the motion of said prey of a fish.

16. The method according to claim 14, wherein said electrolyte is salt water.

17. The method according to claim 14, wherein said electrolyte is fresh water.
